(19) United States
(12) Patent Application Publication
(10) Pub. No.: US 2005/0236441 A1
(43) Pub. Date: Oct. 27, 2005

(54) Caulk saver system

(76) Inventor: Michael Martin, Indianapolis, IN (US)

Correspondence Address: BOSE MCKINNEY & EVANS LLP, 135 N PENNSYLVANIA ST, SUITE 2700, INDIANAPOLIS, IN, 46204, US

(21) Appl. No.: 11/112,587

(22) Filed: Apr. 22, 2005

Related U.S. Application Data
(60) Provisional application No. 60/564,410, filed on Apr. 22, 2004.

(51) Int. Cl. B67D 3/00; B65D 47/00

(52) U.S. Cl. 222/546

(57) ABSTRACT

The present invention relates generally to closures for nozzles. More particularly, the present invention relates to a stopper which may be used to seal a caulk tube. The stopper includes a handle and a stem extending from the handle.

### BACKGROUND AND SUMMARY OF THE INVENTION

[1] The present invention relates generally to closures for nozzles. More particularly, the present invention relates to a stopper which may be used to seal a caulk tube.

[2] It is well known in the art to attempt to seal a caulk tube with nails, caps, plugs or similar devices. One problem is that the nail does not properly seal against the nozzle of a caulk tube allowing the caulk to dry out and become unusable. The present invention overcomes the shortcomings of the prior art to provide a proper seal for caulk tubes.

[3] According to one embodiment of the present invention, a stopper apparatus is provided for use with a caulk tube that includes a nozzle with a length an opening for dispensing caulk. The stopper includes a handle and a stem extending from the handle. The stem includes a first portion, a second portion, a third portion, and a fourth portion. The first portion has a first length and a first diameter. The second portion has a second length and a second diameter. The third portion has a third length and a third diameter. The fourth portion has a fourth length greater than the length of the nozzle. The stem is configured to be positioned within the opening of the nozzle to puncture a seal of the caulk tube and to substantially seal the nozzle using one of the first, second, and third portion depending on the size of the opening.

[4] Additional features and advantages of the invention will become apparent to those skilled in the art upon consideration of the following detailed description of illustrated embodiments exemplifying the best mode of carrying out the invention as presently perceived.

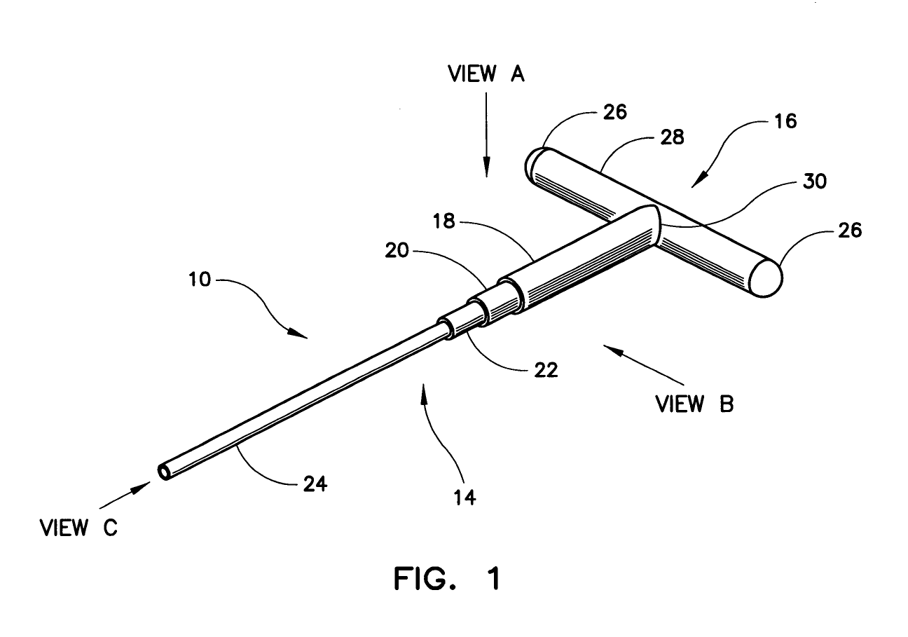

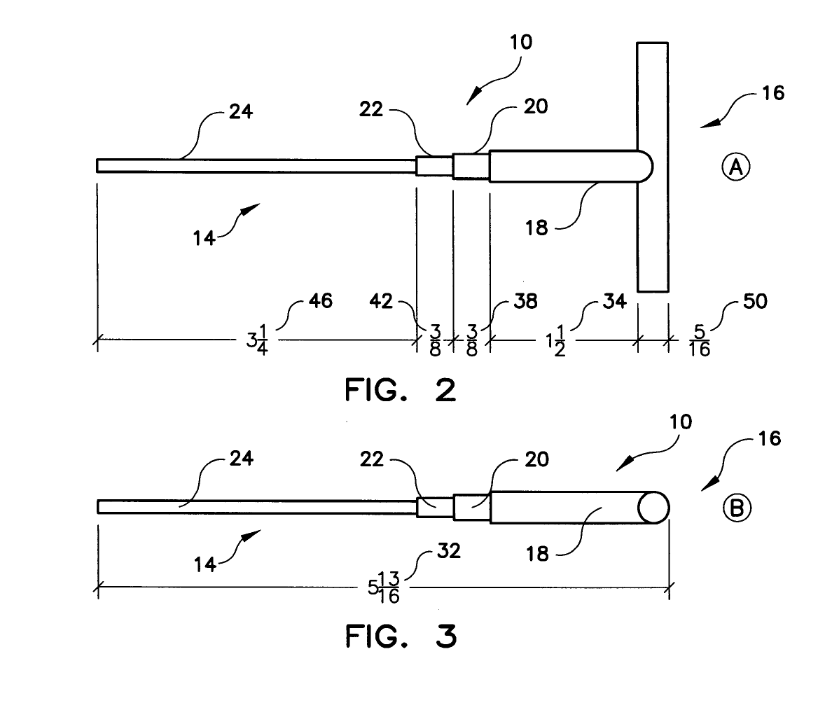

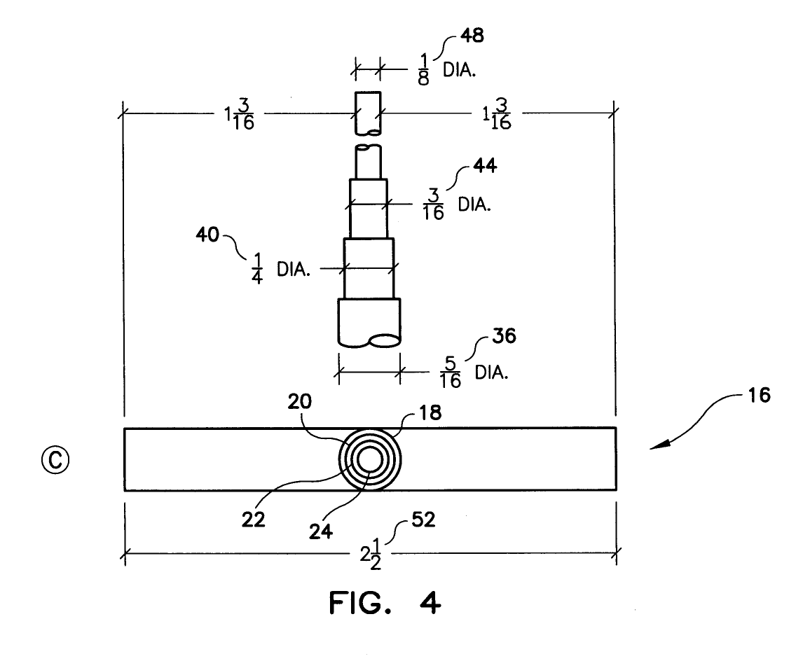

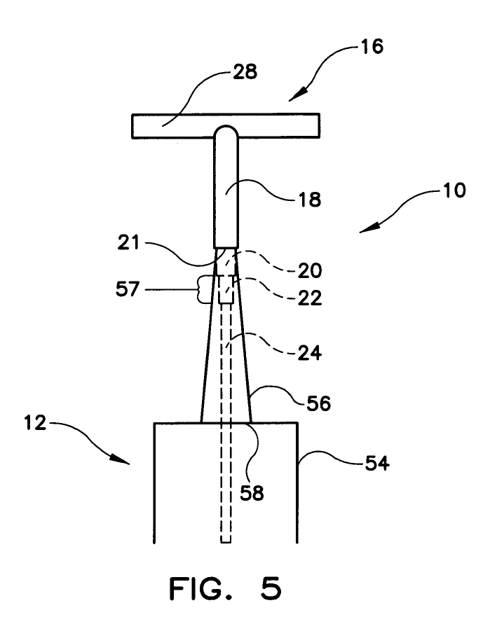

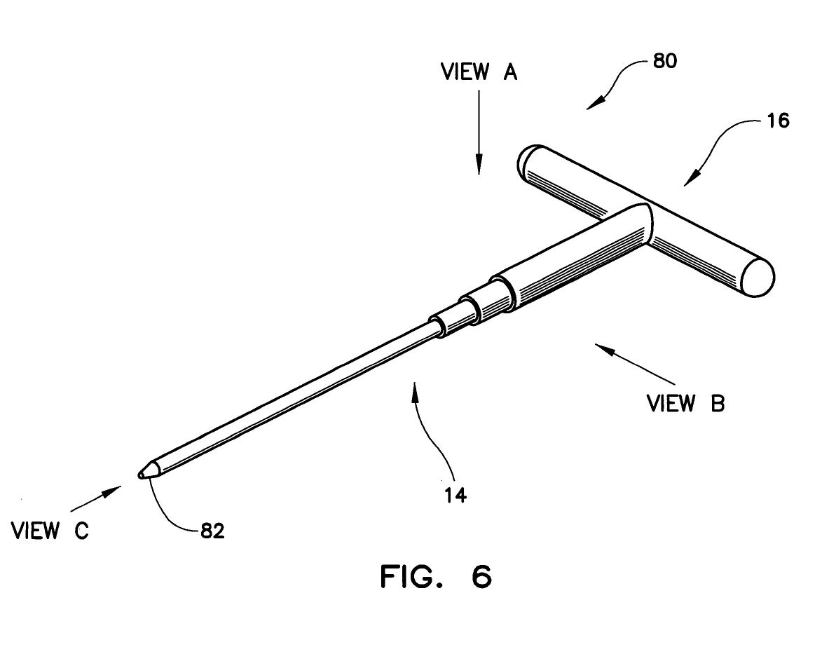

### BRIEF DESCRIPTION OF THE DRAWINGS

[5] A detailed description particularly refers to the accompanying figures in which:

[6] FIG. 1 is a top perspective view of a stopper apparatus of the present invention;

[7] FIG. 2 is a top view of the stopper apparatus shown in FIG. 1;

[8] FIG. 3 is a side view of the stopper apparatus shown in FIG. 1;

[9] FIG. 4 is an end view of the stopper apparatus in the direction as shown in FIG. 1;

[10] FIG. 5 is a view showing the stopper apparatus inserted into a nozzle of a caulk tube to seal an opening in the caulk tube; and

[11] FIG. 6 is a top perspective view of an alternative embodiment of the stopper apparatus shown in FIG. 1;

### DETAILED DESCRIPTION OF THE DRAWINGS

[12] While the present invention is susceptible to various modifications and alternative forms, exemplary embodiments thereof have been shown by way of example in the drawings and will herein be described in detail. It should be understood, however, that there is no intent to limit the invention to the particular forms and methods disclosed, but on the contrary, the intention is to address all modifications, equivalents, and alternatives falling within the spirit and scope of this disclosure as defined by the appended claims.

[13] According to the present disclosure, a stopper apparatus 10 as shown in FIG. 1 is provided to seal a nozzle (not shown). The stopper apparatus 10 of the present invention is designed specifically to save the unused portion of caulk in a caulk tube 12 as shown in FIG. 5. As described in detail below, the stopper apparatus 10 is further configured to puncture a seal present in an unused caulk tube 12. It can be appreciated that the stopper apparatus 10 may be made from any one of many materials including: wood, metal, fiberglass, plastic, or any other suitable material. The stopper apparatus 10 may also be formed by one of many manufacturing processes such as stamping, forming, injection molding, casting, machining or any other suitable process.

[14] As shown in FIGS. 1-4, the stopper apparatus 10 includes a stem 14 and a handle portion 16. Stem 14 includes a first portion 18, a second portion 20, a third portion 22, and a fourth portion 24. It should be understood that any number of portions could be used. Handle portion 16 includes ends 26 and a body 28. Stem 14 is coupled to handle 16 at a coupling joint 30 by adhesive or any other suitable attaching means such as glue, welding, nailing could also be used. In an alternative embodiment (not shown), stem 14 and handle 16 comprise a single unit.

[15] As shown in FIGS. 2-4, the stopper apparatus 10 extends an overall length 32. First portion 18 of stem 14 extends a first length 34 and has a first diameter 36. Second portion 20 extends a second length 38 and has a second diameter 40. Third portion 22 extends a third length 42 and has a third diameter 44. Forth portion 24 extends a fourth length 46 and has a fourth diameter 48. Stem 14 decreases in diameter as it extends from handle portion 16. Diameter 36 is larger than diameter 40 which is larger than diameter 44 which is larger than diameter 48. Handle portion 16 extends a handle length 52 and has a handle diameter 50. Overall length 32 is equal in length to the combine lengths of the first, second, third, and fourth portions 18, 20, 22, 24 plus handle diameter 50. As would be understood by one having ordinary skill in the art, the number of portions and the lengths of the portions can vary and are not limited to the dimensions of the illustrated embodiment.

[16] As shown in FIG. 5, the caulk tube 12 includes a caulk body 54, a nozzle 56, and a seal 58. Nozzle 56 is tapered in shape and includes an opening 21 with a tip (not shown). The tip of nozzle 56 may be cut at various positions along nozzle 56 to provide different sized beads of caulk. Some tubes of caulk have markings 57 where the tip is to be cut to create the different sized beads. Some tubes include markings 57 indicating where the tip should be cut so that nozzle 56 will provide a bead of caulk having a diameter roughly ⅛, 3/16, ¼, or 5/16 of an inch. The stopper apparatus 10 is configured to seal nozzle 56 regardless of where the tip is cut. In the embodiment shown in FIG. 5, first portion 18 is configured to seal the nozzle 56 when the tip is cut for a 5/16″ bead, second portion 20 is configured to seal the nozzle 56 when the tip is cut for a ¼″ bead, third portion 22 is configured to seal the nozzle 56 when the tip is cut for a 3/16″ bead, and fourth portion 24 is configured to seal the nozzle 56 when the tip is cut for a ⅛″ bead and to puncture and extend beyond seal 58 to provide an additional seal.

[17] In use, an operator (not shown) removes the tip by cutting nozzle 56 at one of the ⅛, 3/16″, ¼″ and 5/16″ marking 57. Once the tip is removed the operator grasps the handle portion 16 of the stopper apparatus 10 and thrusts the stopper apparatus 10 until fourth portion 24 of the stem 14 breaks the seal 58 of caulk tube 12. Fourth portion 24 has an overall length longer than nozzle 56 to penetrate the seal without any portion 18, 22, 24 engaging the nozzle 56. The operator then removes the stopper apparatus 10 until the caulk tube 12 is ready for storage. When the tube is ready for storage the operator inserts stopper apparatus 10 into nozzle 56. Depending at which marking the nozzle 56 was cut one of the first, second, third or fourth portions 18, 20, 22, 24 will engage nozzle 56 and seal the caulk tube 12 preventing the caulk from drying out. Fourth portion 24 extends through the puncture in seal 58, created during opening, and may seal the puncture providing an additional air tight seal to aid in preventing the caulk from drying out.

[18] Another embodiment of the stopper apparatus 10 is shown in FIG. 6. The stopper apparatus 80 of FIG. 6 is substantially similar to the stopper apparatus of FIGS. 1-5 with the exception that stopper apparatus 80 includes a point 82. Point 82 is configured to puncture seal 58.

[19] Although the present invention has been described in detail with reference to preferred embodiments, variations and modifications exist within the scope and spirit of the present invention as described and defined in the following claims.

1. A stopper apparatus for use with a caulk tube for dispensing caulk, the caulk tube including a nozzle having a length and an opening for dispensing the caulk, the apparatus comprising:
a handle;
a stem extending from the handle, the stem including a first portion having a first length and a first diameter, a second portion having a second length and a second diameter, a third portion having a third length and a third diameter, and a fourth portion having a fourth length greater than the length of the nozzle;
the stem being configured to be positioned within the opening of the nozzle to puncture a seal of the caulk tube and to substantially seal the nozzle using one of the first, second, third, and fourth portions depending upon a size of the opening of the nozzle.

2. The stopper apparatus of claim 1, wherein the first portion is configured to seal the nozzle when the opening is configured for a 5/16″ bead of caulk.

3. The stopper apparatus of claim 1, wherein the second portion is configured to seal the nozzle when the opening is configured for a ¼″ bead of caulk.

4. The stopper apparatus of claim 1, wherein the third portion is configured to seal the nozzle when the opening is configured for a 3/16″ bead of caulk.

5. The stopper apparatus of claim 1, wherein the fourth portion is configured to seal the nozzle when the opening is configured for a ⅛″ bead of caulk.

6. The stopper apparatus of claim 1, wherein the fourth portion is configured to puncture and extend beyond the opening to provide an additional seal.

7. The stopper apparatus of claim 6, wherein the fourth portion includes a point to puncture the opening.

8. A method of sealing a caulk tube having a nozzle and a seal located within the nozzle, the nozzle including at least two markings for forming an opening having one of two different diameters, the method including the steps of;
cutting the nozzle at least one size marking to form the opening with one of the two diameters;
providing a stopper including a handle and a stem, the stem including a first portion having a first length and a first diameter and a second portion having a second length and a second diameter; and
placing the stopper in the nozzle with one of the first and second portions of the stopper engaging the opening to seal the opening.

9. The method of claim 8, further including the step of thrusting the stopper into the nozzle to puncture the seal.

10. The method of claim 8, wherein the stem includes a third portion having a third length and a third diameter.

11. The method of claim 10, wherein the stem includes a fourth portion having a fourth length greater than the length of the nozzle.
